(19) United States
(12) Patent Application Publication
(10) Pub. No.: US 2017/0130393 A1
(43) Pub. Date: May 11, 2017

(54) Carbon Fibers Having A Modified Surface, Method For Modify-ing A Carbon Fiber Surface, And Use Of The Carbon Fiber

(71) Applicant: Siemens Aktiengesellschaft, Muenchen (DE)

(72) Inventors: Florian Eder, Erlangen (DE); Marek Maleika, Fuerth (DE); Heinrich Zeininger, Obermichelbach (DE)

(73) Assignee: Siemens Aktiengesellschaft, Muenchen (DE)

(21) Appl. No.: 15/321,937

(22) PCT Filed: May 27, 2015
(86) PCT No.: PCT/EP2015/061743

§ 371 Date: Dec. 23, 2016

(30) Foreign Application Priority Data
Jun. 25, 2014 (DE) 10 2014 212 241.4

(51) Int. Cl. D06M 13/513; D06M 15/55; D06M 10/08; C08J 5/06

(52) U.S. Cl. CPC D06M 13/513; C08J 5/06; D06M 15/55; D06M 10/08; C08J 2300/00; D06M 2101/40

(57) ABSTRACT

Carbon fibers that can be used for carbon-fiber composite plastics are disclosed. A carbon fiber may include a thin but hard plasma coating with amorphous, i.e., vitreous, siloxane on the carbon fiber. The carbon fiber is thus provided with a surface that can be processed like a glass fiber surface.

### CROSS-REFERENCE TO RELATED APPLICATIONS

This application is a U.S. National Stage Application of International Application No. PCT/EP2015/061743 filed May 27, 2015, which designates the United States of America, and claims priority to DE Application No. 10 2014 212 241.4 filed Jun. 25, 2014, the contents of which are hereby incorporated by reference in their entirety.

### TECHNICAL FIELD

The invention relates to carbon fibers, in particular those used for carbon-fiber-plastics composites (CFRPs).

### BACKGROUND

When carbon fibers are incorporated into fiber-plastics composites a particularly decisive part is played by the surface of the carbon fibers, because the molecular condition of the carbon-fiber surface has a decisive effect on the bonding of the carbon fiber to the matrix, and thus on the stability of the fiber-reinforced material.

It is known that carbon fibers can be subjected to anodic oxidation followed by coating with an epoxy-based size. The size is relatively thin (<100 nm). The first effect of the anodic oxidation is activation of the nonpolar graphite-like surface. By way of example, graphite oxides and graphite hydroxides are formed here. Solution chemistry methods are then used to coat these surface-activated carbon fibers with an epoxy-containing lacquer solution, and said fibers can be converted into rovings of up to 60,000 filaments.

Despite this treatment, fracture tests, in particular those for testing the suitability of carbon-fiber-reinforced materials for components subject to high loads, continue to show that the carbon fiber can easily be withdrawn from the matrix. This reveals that bonding of carbon fiber to the matrix resin is still too weak, even after the treatment with size. The fiber-reinforced plastics composites therefore lack the required stiffness and strength.

The known thin size is often removed from the fiber by abrasion during preform processes and also during braiding and passage over deflector rolls. On incorporation into the matrix, adhesion of the matrix material to the carbon fiber at these locations is then unsatisfactory, because at those locations the matrix material comes into contact with the graphite-like surface, which is nonpolar and has no “anchor points” such as the hydroxide points and/or oxide points formed by anodic oxidation on the treated carbon fiber. Said locations weaken the entire resultant carbon-fiber-plastics composites, because adhesion of the matrix resin at low-polarity locations is poor.

### SUMMARY

One embodiment provides a carbon fiber with modified surface which has a siloxane-containing coating with layer thickness less than 1 μm.

In one embodiment, the carbon fiber additionally includes further coatings.

In one embodiment, the siloxane-containing coating is located between the carbon fiber and a coating applied by solution chemistry.

In one embodiment, the carbon fiber includes a coating made of an epoxy resin on the siloxane-containing coating.

In one embodiment, the carbon fiber includes at least one further siloxane-containing coating provided on the first, thin siloxane-containing coating.

Another embodiment provides a process for the surface modification of a carbon fiber, wherein a carbon fiber with a siloxane-containing coating is produced by way of plasma coating.

In one embodiment, the process is performed in atmospheric plasma.

In one embodiment, the modification of the carbon fiber surface and the coating with the amorphous siloxane-containing coating occurs in a plasma-treatment step.

Another embodiment provides for the use of a carbon fiber as disclosed above for the production of a fiber-plastics composite.

### DETAILED DESCRIPTION

Embodiments of the present invention provide surface-modified carbon fibers for incorporation into carbon-fiber-reinforced plastics, and also a process for the surface-modification of carbon fibers.

Some embodiments provide a surface-modified carbon fiber which has a siloxane-containing coating. Other embodiments provide a process for the surface modification of a carbon fiber, wherein a carbon fiber with a siloxane-containing coating is produced by plasma coating.

The expression siloxane-containing coating here means a thin, amorphous, i.e. vitreous, coating of thickness at most 500 nm made of SiOₓ.

The expression “surface-modified carbon fiber” means a carbon fiber whose original graphite-like surface is modified by a process, i.e. is activated for reaction, where this involves a coating material. The prior art uses anodic oxidation to achieve the modification, but the invention uses plasma to carry out the modification. It may be preferable that, before coating, the surface of a carbon fiber is modified, advantageously activated by way of plasma.

After production of the carbon fibers, these are therefore not, or not only, subjected to anodic oxidation, but instead are activated in a plasma, for example in an atmospheric plasma.

It is advantageous to produce the plasma entirely or to some extent with use of silane-containing precursors, and thus to coat the carbon fiber with a vitreous layer.

Alternatively, or in addition to the above, it is also possible to achieve activation simply by using an AP plasma (atmospheric-pressure plasma) in nitrogen N₂/air.

Unlike an activated plasma coating, the activation lasts only for a few hours, and does not increase the density of polar groups on the surface of the carbon fiber. This can be demonstrated by measuring wettability by the method of Owens, Wendt, Rabel, and Kälble. The contact angle accordingly decreases from 61° for the poorly wettable, untreated carbon-fiber surface to less than 10° for the carbon-fiber surface treated by plasma activation. This means that the water droplet spreads comparatively rapidly on the plasma-activated surface of the carbon fiber and wets the surface.

In one embodiment of the invention, activation of the carbon-fiber surface and coating are carried out in a single plasma treatment, in particular when the precursors for the plasma coating are activated by air.

During activation in the plasma, the surface of the carbon fiber becomes charged and ionized, and/or free-radicals are formed. The ionized plasma gasses bond to surface atoms. Molecular groups produced depend on the ionization gas and are as follows:
—C—O,
—COH,
—C—N,
—C—NH,
—C—OO.

These then react with the ionized fragments of the silane precursors to give —C—O—Si—R (R═O, OH, OSi, OSiOH, . . . ).

In a subsequent reaction, the new surface molecules are reacted with one another to give an amorphous siloxane layer. The siloxane layer can be controlled via nozzle velocity or change of process parameters such as precursor quantity, plasma power, nozzle geometry, etc.

The layer thicknesses produced are in the nanometer range, therefore being thinner than 1 μm, in particular being below 500 nm, for example in the range from 10 to 300 nm, in particular from 20 to 200 nm, and in some embodiments in the range from 50 to 150 nm.

Example aspects of the invention are explained in more detail below with reference to examples of modification of the carbon-fiber surface with use of, by way of example, AP plasma:

### Example 1

Plasma Activation and/or Thin Plasma Coating of the Carbon-Fiber Surface:

Good adhesion of the siloxane layer is achieved via chemical bonding of activated atoms on the carbon-fiber surface to the ionized silane fragments.

### Example 2

Use of epoxy-containing lacquers in a solution-chemistry method analogous to glass-fiber coating to coat the carbon-fiber surface already modified by amorphous siloxane by virtue of example 1.

The siloxane layer formed via plasma, in particular via AP plasma, adheres very well on the carbon-fiber surface. An epoxy coating subsequent thereto provides better adhesion of the epoxy coating on the siloxane layer than on the carbon-fiber surface subjected to a conventional anodic oxidation process of the type known hitherto.

### Example 3

Increase of the layer thickness of the plasma coating via change of process parameters or by way of a further plasma coating on the amorphous SiOₓ layer with use of similar siloxanized precursors (e.g. HMDSO, TEOS, VTMS).

Even without additional coating by solution-chemistry efforts, as carried out in example 2, this process provides, on the carbon-fiber surface, an amorphous SiOₓ layer which withstands relatively aggressive conditions in processing of the carbon fiber (braiding, roll-up etc.), i.e. by way of example accelerated processing. A particular reason for this is that an amorphous SiOₓ layer is harder than the organic epoxy-resin layer which the prior art applies on the carbon fiber and which in example 1 contributes substantially to the layer thickness and forms the outermost coating of the carbon fiber.

Whereas in the case of anodically oxidized fibers about 5% of oxygen is present at the surface in functional groups, for example —C—OR and —COOR, the plasma coating increases oxygen content at the surface to about 30% or preferably, through use of mixtures comprising high TEOS content, to more than 50%. The functional groups are —COR, —COOR, C═O, and also —Si(—O)₃ and Si(—O)₄ groups. The concentration of oxygen in the layer of approximately 5 nm close to the surface is demonstrated by XPS photoelectron spectroscopy.

The significantly increased concentration of polar groups leads to increased wetting and adhesion of the size, a thermoplastic matrix and/or a resin matrix.

The invention provides the first proposal for a thin, but hard, plasma coating with use of amorphous, i.e. vitreous, siloxane on a carbon fiber. The processing properties of the resultant carbon-fiber surface are similar to those of a glass-fiber surface.

What is claimed is:

1. A carbon fiber, comprising:
a surface having a siloxane-containing coating with a layer thickness of less than 1 μm.

2. The carbon fiber of claim 1, further comprising at least one additional coating.

3. The carbon fiber of claim 2, comprising an additional coating applied over the siloxane-containing coating by solution chemistry.

4. The carbon fiber of claim 3, wherein the additional coating applied over the siloxane-containing coating by solution chemistry comprises an epoxy resin.

5. The carbon fiber of claim 1, comprising at least one further siloxane-containing coating provided on the siloxane-containing coating having the layer thickness less than 1 μm.

6. A process for surface modification of a carbon fiber, comprising:
activating a surface of a carbon fiber using plasma; and
forming a siloxane-containing coating on the activated surface of the carbon fiber by plasma coating.

7. The process of claim 6, wherein the siloxane-containing coating is formed in atmospheric plasma.

8. The process of claim 6, comprising performing the activation of the carbon fiber surface and the coating with the amorphous siloxane-containing coating in a plasma-treatment step.

9. (canceled)

10. The process of claim 6, comprising forming the siloxane-containing with layer thickness of less than 1 μm.

11. The process of claim 6, comprising forming the siloxane-containing with layer thickness in the range from 10 to 300 nm.

12. The process of claim 6, comprising forming the siloxane-containing with layer thickness in the range from 50 to 150 nm.

13. The process of claim 6, further comprising forming an additional coating over the siloxane-containing coating by solution chemistry.

14. The process of claim 13, wherein the additional coating formed over the siloxane-containing coating by solution chemistry comprises an epoxy resin.

15. The process of claim 6, further comprising forming at least one further siloxane-containing coating over the siloxane-containing coating.

16. The carbon fiber of claim 1, wherein the siloxane-containing coating has a layer thickness in the range from 10 to 300 nm.

17. The carbon fiber of claim 1, wherein the siloxane-containing coating has a layer thickness in the range from 50 to 150 nm.

18. A method of forming a fiber-plastics composite, comprising:
producing a plurality of carbon fibers having a modified surface by a process including:
activating a surface of each carbon fiber using plasma; and
forming a siloxane-containing coating on the activated surface of each carbon fiber by plasma coating; and
using the plurality of carbon fibers to form a fiber-plastics composite.
